(19) United States
(12) Patent Application Publication
(10) Pub. No.: US 2020/0106685 A1
(43) Pub. Date: Apr. 2, 2020

(54) LOW VARIANCE ESTIMATION OF NETWORK EFFECTS

(71) Applicant: Microsoft Technology Licensing, LLC, Redmond, WA (US)

(72) Inventors: Kinjal Basu, Stanford, CA (US); Shaunak Chatterjee, Sunnyvale, CA (US); Ajith Muralidharan, Sunnyvale, CA (US); Ye Tu, Sunnyvale, CA (US)

(21) Appl. No.: 16/145,024

(22) Filed: Sep. 27, 2018

(51) Int. Cl. H04L 12/26; G06F 17/50

(52) U.S. Cl. CPC H04L 43/08; G06F 2217/16; G06F 17/5009

(57) ABSTRACT

Techniques for minimizing variance in the estimation of the effects of a treatment on an online network are disclosed herein. In some embodiments, a computer system determines different permutations of selection parameters for selecting treatment entities from an online network of entities, calculating a corresponding variance in an effect value representing an effect of a treatment on the online network for each permutation of selection parameters in the plurality of permutations of selection parameters, selecting one of the different permutations of selection parameters based on the corresponding variance of the different permutation of selection parameters being lower than the corresponding variances of all of the other permutations of selection parameters, selecting a group of treatment entities from the online network of entities based on the selected permutation of selection parameters, and applying the treatment to the group of treatment entities based on the selecting of the group of treatment entities.

### TECHNICAL FIELD

The present application relates generally to systems, methods, and computer program products for minimizing variance in the estimation of the effects of a treatment on an online network.

### BACKGROUND

Experiments may be run on an online service to determine what effect a feature may have on the online service when introduced on the online service. Such experiments may involve a treatment group to which the feature is applied as part of the experiment, as well as a control group to which the feature is not applied as part of the experiment. Accurately measuring the effects of a feature is particularly challenging when the environment in which the feature is to be applied is an online network in which edges are formed between entities. While prior technology for experimentation exists for entity-level experiments, such prior technology does not effectively consider how features may affect the rest of the online network. For example, such prior technology for experimentation does not address the fact that when a feature is applied to one entity of an online network, it may have an effect on other entities of the online network. As a result, such prior art solutions for experimentation for online networks does not accurately predict the effects of the feature, thereby often leading to features that will negatively impact the online network sneaking through the experimentation to be implemented on the online network. Thus, the function of the computer system of the online network suffers. Additionally, prior art solutions use cluster-based randomization, which suffers from problems with accuracy and scalability, particularly when involving online networks involving a dense network of entities, as they do not allocate entities of a online network to a treatment group for an experiment in a way that sufficiently addresses the network effect of a treatment applied on one entity of the online network impacting other entities of the online network. Other technical problems may arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating a network effects estimation system, in accordance with an example embodiment.

FIG. 4 is a block diagram illustrating a conceptual representation of an online network of entities, in accordance with an example embodiment.

FIG. 5 illustrates the relationship between selection parameters and the selection of treatment entities and control entities from an online network of entities, in accordance with an example embodiment.

FIG. 6 is a flowchart illustrating a method of minimizing variance in the estimation of the effects of a treatment on an online network, in accordance with an example embodiment.

FIG. 7 is a block diagram illustrating a mobile device, in accordance with some example embodiments.

FIG. 8 is a block diagram of an example computer system on which methodologies described herein may be executed, in accordance with an example embodiment.

### DETAILED DESCRIPTION

Example methods and systems of minimizing variance in the estimation of the effects of a treatment on an online network are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. In some example embodiments, a computer system calculates, for each one of a plurality of different selection parameters, a corresponding variance for an effect of a treatment on an online network. The selection parameters are specifically tailored to accurately predict the effect that the treatment will have on the online network. In contrast to prior art experimentation solutions that only evaluate the effect of a treatment on a single entity in isolation without considering the network effect that ripples throughout the online network as a result of the treatment being applied to that single entity, the solution implemented by the computer system of the present disclosure evaluates the effect that the treatment being applied to an entity has on other entities that are connected to that entity. The computer system selects permutation of selection parameters that has the lowest corresponding variance, and then selects which entities of the online network to apply the treatment using the selected permutation of selection parameters.

By applying the solution disclosed herein, some technical effects of the system and method of the present disclosure are to minimize the variance in experimentation of a treatment on an online network, thereby significantly improving the accuracy of predicting the effects of the treatment on the online network. As a result, the computer system avoids implementing treatment features on the online network that will hinder the functioning (e.g., slow down) of the computer system. Additionally, by using the features disclosed herein to smartly allocate entities of the online network to a treatment group for an experiment, the solution disclosed herein enables computer system to efficiently run multiple experiments at the same time, which is a critical requirement for the computer system to iterate faster on the models that are used to implement the online service(s) that it provides. Prior art solutions use cluster-based randomization, which is much less accurate and scalable than the solution disclosed herein, particularly when involving online networks involving dense social graphs, such as with certain social networking services. Other technical effects will be apparent from this disclosure as well.

In some example embodiments, operations are performed by a computer system (or other machine) having a memory and at least one hardware processor, with the operations comprising: determining a plurality of different permutations of selection parameters for selecting treatment entities from an online network of entities, the selection parameters comprising a percentage of entities of an online network of entities to be selected for use as treatment entities, a probability by which a first entity in the online network of entities will have a common treatment type with a second entity that is connected by a first degree with the first entity, and a probability by which the first entity in the online network of entities will have a common treatment type with a third entity that is connected by a first degree with the second entity; for each permutation of selection parameters in the plurality of permutations of selection parameters, calculating a corresponding variance in an effect value representing an effect of a treatment on the online network; selecting one of the plurality of different permutations of selection parameters based on the corresponding variance of the one of the plurality of different permutations of selection parameters being lower than the corresponding variances of all of the other permutations of selection parameters in the plurality of different permutations of selection parameters; selecting a group of treatment entities from the online network of entities based on the selected one of the plurality of different permutations of selection parameters; and applying the treatment to the group of treatment entities based on the selecting of the group of treatment entities.

In some example embodiments, the calculating the corresponding variance in the effect value comprises, calculating, for each one of a plurality of entities of the online network of entities, a corresponding effect value representing an effect of the treatment on the one of the plurality of entities based on an estimation model, the estimation model being based on: a number of first degree connection entities of the one of the plurality of entities that share a common treatment type from amongst a plurality of treatment types with the one of the plurality of entities; for each first degree connection entity of the one of the plurality of entities, a number of first degree connection entities of the first degree connection entity of the one of the plurality of entities that share a common treatment type from amongst a plurality of treatment types with the first degree connection entity of the one of the plurality of entities, the plurality of treatment types comprising a treated entity and a control entity; and for each first degree connection entity of the one of the plurality of entities, a number of second degree connection entities of the one of the plurality of entities that are also a first degree connection entity of the first degree connection entity of the one of the plurality of entities.

In some example embodiments, the estimation model is based on a proportion of the number of first degree connection entities of the one of the plurality of entities that share a common treatment type from amongst the plurality of treatment types with the one of the plurality of entities to a total number of all first degree connection entities of the one of the plurality of connection entities.

In some example embodiments, the calculating the corresponding effect values for the plurality of entities comprises performing a regression algorithm to generate the estimation model.

In some example embodiments, the estimation model comprises a linear model. In some example embodiments, the online network comprises a social network.

In some example embodiments, the treatment comprises boosting display of online content of particular entities of the online network based on one or more criteria.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

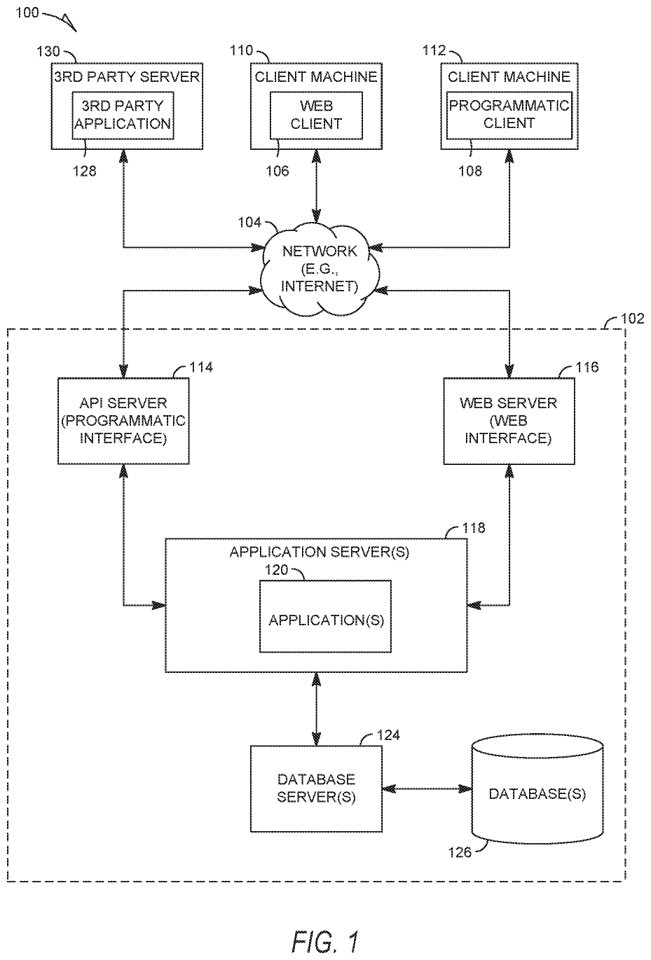

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

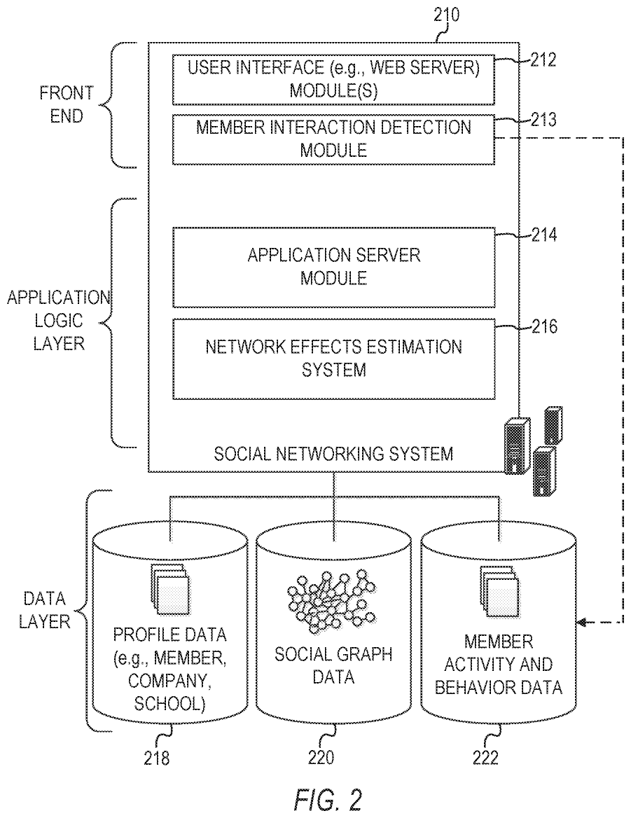

In some embodiments, the networked system 102 may comprise functional components of a social networking service. FIG. 2 is a block diagram showing the functional components of a social networking system 210, including a data processing module referred to herein as a network effects estimation system 216, for use in social networking system 210, consistent with some embodiments of the present disclosure. In some embodiments, the network effects estimation system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the network effects estimation system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the network effects estimation system 216. The members' interactions and behavior may also be tracked, stored, and used by a network effects estimation system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the network effects estimation system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

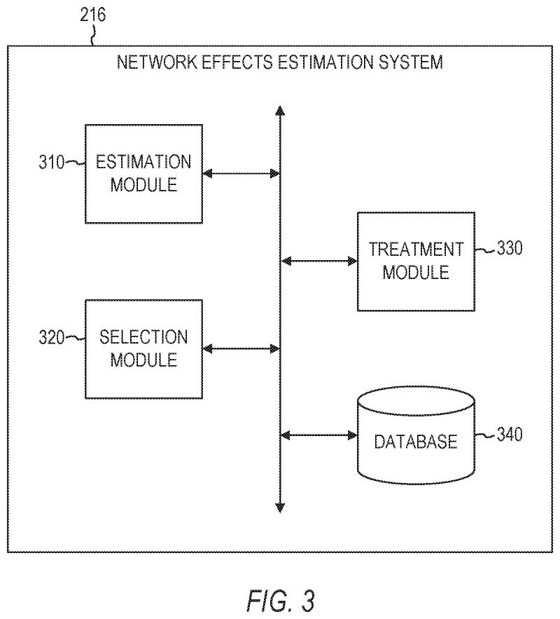

FIG. 3 is a block diagram illustrating the network effects estimation system 216, in accordance with an example embodiment. In some embodiments, the network effects estimation system 216 comprises any combination of one or more of an estimation module 310, a selection module 320, a treatment module 330, and one or more databases 340. The modules 310, 320, and 330 and the database(s) 340 can reside on a computer system, or other machine, having a memory and at least one processor (not shown). In some embodiments, the modules 310, 320, and 330 and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the modules 310, 320, and 330, as well as the database(s) 340, are also within the scope of the present disclosure.

In some example embodiments, one or more of the modules 310, 320, and 330 is configured to perform various communication functions to facilitate the functionality described herein, such as by communicating with the social networking system 210 via the network 104 using a wired or wireless connection. Any combination of one or more of the modules 310, 320, and 330 may also provide various web services or functions, such as retrieving information from the third party servers 130 and the social networking system 210. Information retrieved by the any of the modules 310, 320, and 330 may include profile data corresponding to users and members of the social networking service of the social networking system 210.

Additionally, any combination of one or more of the modules 310, 320, and 330 can provide various data functionality, such as exchanging information with the database(s) 340 or servers. For example, any of the modules 310, 320, and 330 can access member profiles that include profile data from the database(s) 340, as well as extract attributes and/or characteristics from the profile data of member profiles. Furthermore, the one or more of the modules 310, 320, and 330 can access profile data, social graph data, and member activity and behavior data from the database(s) 340, as well as exchange information with third party servers 130, client machines 110, 112, and other sources of information.

In some example embodiments, the network effects estimation system 216 is configured to measure the effect of a treatment on an entity, such as a member of a social networking service, where the impact on the entity is largely impacted by that the network of the entity is also experiencing (e.g., the impact on a member of a social networking service is largely impacted by what the member's social network is experiencing). In some example embodiments, networks effects estimation system 216 is configured to measure the effect of the treatment based on the fraction of the entity's network exposed to the treatment and the fraction of each of the original entity's connections who are exposed to the treatment. In some example embodiments, a label propagation mechanism is employed by the network effects estimation system 216 to smartly allocate entities to the treatment group of the experiment and other entities to the control group of the experiment in order to enable the network effects estimation system 216 to obtain a reliable (e.g., low bias) measurement with low uncertainty (e.g., low variance).

A treatment is a particular process or intervention that is specified in a design of an experiment, which is the design of any task that aims to describe or explain the variation of information under conditions hypothesized to reflect the variation. An experiment applies a particular treatment to a treatment group and measures the effect of the treatment on that treatment group, and may compare the effect of the treatment on that treatment group with respect to the effect of not applying the particular treatment on a control group. For example, an online service may want to perform an experiment to measure the effect of using a red selectable button as part of its user interface compared to using a blue selectable button, such as by comparing the behavior (e.g., click rate) of the users presented with the red selectable button to the behavior (e.g., click rate) of the users presented with the blue selectable button. However, while traditional mechanisms for measuring the effect of such a treatment exist, they are incapable of accurately estimating the effect of treatments that impact an online network or entities, as opposed to only a single entity (e.g., user) at a time.

Social networks (e.g., LinkedIn, Facebook, Instagram, and Twitter) rely on edge formation between members in a social graph, and driving interactions along those edges. A key challenge is then to measure the effectiveness of experiments designed to make edge formation or edge utilization better. While prior technology for experimentation may suffice for member level experiments, the edge effects and require more nuanced consideration. In one example, edges are formed between content producers and content consumers or between source members and destination members.

Measuring producer-side effects in the aforementioned setting is a challenging task, especially because the treatments have a strong network effect—the effect on the producer changes as more consumers connected to the producer get exposed to the treatment. The present disclosure defines a setup that can help in estimating the causal effect by appropriately parameterizing the flow of information in the network structure. In one example, assume that the goal is to measure one or more user metrics on the producer side. One example experiment is boosting all good producers (e.g., users who are identified as posting or otherwise producing good online content) who do not have sufficient exposure to consumers who lack good content (e.g., users who are identified as not being presented with online content that has been identified as good). In some example embodiments, boosting comprises displaying content of a user in a more preferential position than the content would otherwise be displayed without the boost, such as displaying the content to another user when the content would otherwise not be displayed to that other user, or displaying the content in a higher or otherwise better display position than the content would otherwise be displayed without the boost. The content of a user that may be boosted includes, but is not limited to, postings or other content published by the user, as well as the user's profile.

So, thinking about this experiment in an ideal setting, the end goal is to boost 100% of eligible producers for 100% eligible consumers with the aim of estimating this effect using smaller ramps. Since the overall experiment depends both on the consumer and the producer, we start by separately identifying the treatment from the producer side and the consumer side. For the ith member let:
Zᵢ=1, if the i-th member is going to be boosted as a producer by some mechanism; 0, if he is not boosted;
Wᵢ=1, if the i-th member is capable of seeing the boosted producers; and 0, if he is incapable of seeing the boost.
   Given, these two variables, let Yᵢ(Z,W) denote the potential outcome on user i when he is given treatment (Z,W). What we are interested in is to measure,

τ=Y(1,1)−Y(0,0),

where Y(1,1) denotes the average effect when the entire population is boosted and capable of seeing the boost, and Y(0,0) denotes the average effect when the entire population is not boosted and not capable of seeing any boost.

Estimation of τ is a hard problem, since the potential outcomes Yᵢ(Z,W) depend not only on the treatments given to user i, but also on its first and second degree neighbours. To see this more clearly, imagine this from a consumer's point of view. If there is only 5% of his producers who are boosted, his behaviour is quite different than what it would be if all 100% of his producers are boosted. This effect is known as the network effect which violates the usual Stable Unit Treatment Value Assumption (SUTVA) for regular A/B tests, which requires that the potential outcome observation of one unit should be unaffected by the particular assignment of treatments to the other units. In order to effectively estimate T by smaller ramps, the network effects estimation system 216 may employ the following methodology to appropriately model the network effect.

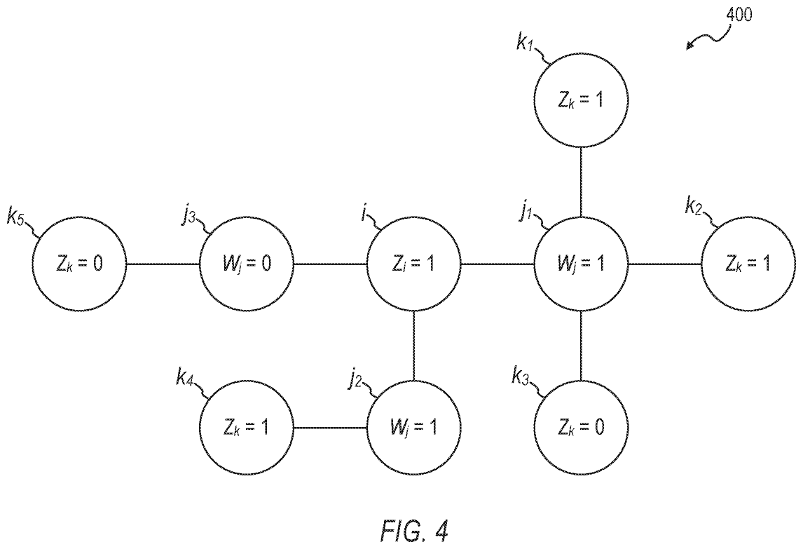

Producer side metrics are hard to estimate, since they suffer from the network effect, which may include network dependency. In one example of network dependency, for a producer i who has Z, =1, his metrics depend on which consumers in his network have Wⱼ=1, and, for those consumers, how much competition he has from other producers in this network are also eligible to be boosted. FIG. 4 provides additional perspective on this issue.

FIG. 4 is a block diagram illustrating a conceptual representation 400 of an online network of entities, in accordance with an example embodiment. In the conceptual representation 400, entities are represented as nodes (e.g., circles), and relationships between entities are represented as edges (e.g., lines) connecting the entity nodes. The example of FIG. 4 is discussed in the context of measuring the outcome for the entity node i, for which Zᵢ=1. The entity node i has the following neighbour entity nodes (e.g., entities that are directly connected to the entity node i) j₁, j₂, and j₃, j₁ has neighbour entity nodes k₁, k₂, and k₃, j₂ has neighbour entity node k₄, and j₃ has neighbour entity node k₅. In this example, the information is flowing from the first layer which has Wⱼ=1 and from the second layer which have Zₖ=1. In some example embodiments, the network effects estimation system 216 employs a label generation mechanism to identify these member treatments. This technique is used in order to reduce the variance of the final estimate. The following modelling approach helps explain the advantage of a label propagation scheme. In some example embodiments, the network effects estimation system 216 uses the following linear model for the potential outcome:

$${Y}_{i , t} - {Y}_{i , t - 1} = μ + {α}_{1} {Z}_{i} + {β}_{1} {η}_{i}^{1} {Z}_{i} + {β}_{0} {n}_{i}^{0} ( 1 - {Z}_{i} ) + {\sum }_{k = 0}^{1} {γ}_{k} {\sum }_{j ∈ {N}_{i}} {ξ}_{ij} {σ}_{j}^{k} ,$$

where:
Nᵢ denotes the set of first degree connections of i;
ηᵢ denotes the proportion of 1st degree connections of i, who share the same treatment type, e.g., Wⱼ=Zᵢ;
σⱼ denotes the proportion of 1st degree connections of j, who have who share the same treatment type, e.g., Zₖ=Wⱼ; and
ξᵢⱼ denotes the proportion of the second degree connections of i through j.

In the example shown in FIG. 4, ηᵢ is ⅔ because entity node i has three neighbours j₁, j₂, and j₃, and two of those neighbours, j₁ and j₂, share the same treatment type (1) as i, whereas the third neighbour j₃ has the opposite treatment type (0). σⱼ denotes the proportion of the first degree neighbours of j, which is a first degree neighbour of i, that share the same treatment type as j. Therefore, in the example shown in FIG. 4, σⱼ of j₁ is ¾ because j₁ has four neighbours (i, k₁, k₂, and k₃) and three of those neighbours (i, k₁, and k₂) have the same treatment type (1) as j₁. In the example shown in FIG. 4, σⱼ of j₂ is 1 because j₂ has two neighbours (i and k₄) and both of those neighbours share the same treatment type (1) as j₂. In the example shown in FIG. 4, σⱼ of j₃ is ½ because j₃ has two neighbours (i and k₅) and one of those neighbours (k₅) shares the same treatment type (0) as j₃. In the example shown in FIG. 4, ξᵢⱼ of j₁ is ⅗ because i has five 2^{nd} degree connections (k₁, k₂, k₃, k₄, and k₅) and three of those 2^{nd} degree connections (k₁, k₂, and k₃) are through j₁, ξᵢⱼ of j₂ is ⅕ because one of i's 2^{nd} degree connections (k₄) is through j₂, and ξᵢⱼ of j₃ is ⅕ because one of i's 2^{nd} degree connections (k₅) is through j₃.

Although example embodiments discussed herein use bi-lateral relationships such as connections, it is contemplated that unilateral relationships such as one user following another user may be used in addition or as an alternative to the use of bi-lateral relationships. Similarly, recommended relationships, such as a recommended connection between two users or a recommended following of one user by another user, may also be used in addition or as an alternative to the use of bi-lateral relationships.

In some example embodiments, once the network effects estimate system 216 has the model data discussed above, it can estimate the causal effect by estimating the coefficients through an appropriate regression. More complicated dependencies can also be generated following this setup. In some example embodiments, once the network effects estimate system 216 has the coefficients, it estimates the causal effect τ as:

\hat{τ}=α₁+β₁−β₀.

Although the above formulation is an unbiased estimator given the model, there is inherent bias in the kind of data that we have in order to estimate these coefficients. In some example embodiments, for a small ramp, the network effects estimation system 216 can only observe values where ηᵢ and σᵢ are really small. However, in estimating the causal effect, an attempt can be made to predict the value when ηᵢ=σᵢ=1. This creates an inherent sampling bias in the problem. To overcome this issue, in some example embodiments, the network effects estimation system 216 uses an experimental procedure that enables the recording of relatively larger values of ηᵢ and σᵢ, so that this systematic bias can be reduced.

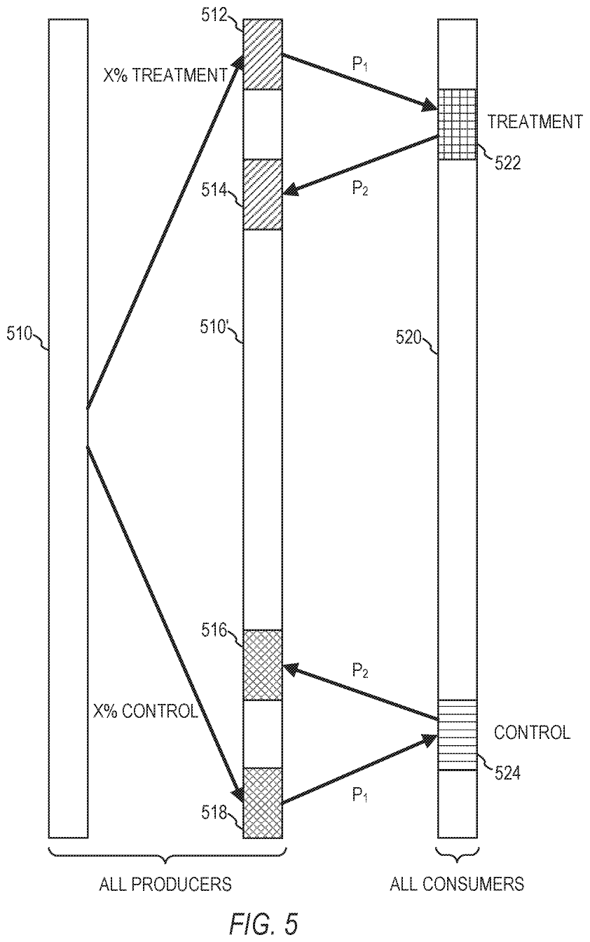

In some example embodiments, the network effects estimation system 216 determines selection parameters for selecting treatment entities and control entities for an experiment. In some example embodiments, the network effects estimation system 216 uses a label propagation scheme to generate treatment types for the entities using parameters x, p₁, and p₂. FIG. 5 illustrates the relationship between selection parameters x, p₁, and p₂ and the selection of treatment entities and control entities from an online network of entities, in accordance with an example embodiment.

In FIG. 5, the bar 510 represents all of the producers in the online network that are available for selection as treatment entities, as well as available for selection as control entities. x denotes the initial percentage of entities of the online network (e.g., producer members of the online network) who will be randomly picked by the network effects estimation system 216 to be used as treatment entities in an experiment. x may also be used as the initial percentage of entities of the online network who will be randomly picked by the network effects estimation system 216 to be used as control entities in the experiment. Thus, overall, the total percentage of members picked may be 2x %. In FIG. 5, bar 510′ shows that x % of the producers, represented by segment 512, have been selected as treatment entities for the experiment, and x % of the producers, represented by segment 518, have been selected as control entities for the experiment.

p₁ denotes the probability by which a consumer in the network of a producer will get the same treatment as the producer. This probability accounts for first order effects. The consumers receiving the same treatment as the producer are represented in FIG. 5 by segment 522 of bar 520 for the consumers receiving the same treatment as the treatment entities 512, and by segment 524 of bar 520 for the consumers receiving the same treatment as the control entities 518. In some example embodiments, the treatment of the consumer is defined by the highest occurring treatment edge. In the case of ties, the network effects estimation system 216 breaks them at random from the competing set. For example, if a member gets five edges from treatment and three edges from control, then that member will belong to treatment. Correspondingly, if that member gets three edges from treatment and three edges from control, then the network effects estimation system 216 randomly assigns a treatment to that member between treatment and control.

p₂ denotes the propagation probability from the consumer back to the producer. In FIG. 5, segments 514 and 516 of bar 510′ represent the respective producers to whom the treatment of the treatment entities 522 and the control entities 524, respectively, has been propagated. If the producer was already marked in the initial sampling, then that treatment will remain. Otherwise, the network effects estimation system 216 follows the same procedure as above.

The variance of the estimator \hat{τ}=α₁+β₁−β₀, can be directly attributed to the parameters in the label propagation. Specifically, if we define the feature vector as:

$${X}_{i} = ( 1 , {Z}_{i} , {Z}_{i} {η}_{i}^{1} , ( 1 - {Z}_{i} ) {η}_{i}^{0} , {\sum }_{j ∈ {N}_{i}} {ξ}_{ij} {σ}_{j}^{0} , {\sum }_{j ∈ {N}_{i}} {ξ}_{ij} {σ}_{j}^{i} ) ,$$

then Var(\hat{τ})=σ²×(0,1,1,−1,0,0)^{T}(X^{T}X)⁻¹ (0,1,1,−1,0,0).

Since the above matrix (X^{T}X)⁻¹ is a function of x, p₁, and p₂, the network effects estimation system 216 can estimate the variance as it varies these selection parameters. Moreover, for each choice of x, p₁, and p₂, the network effects estimation system 216 can estimate the number of active edges in the experiment. These two are conflicting in nature, and hence, for a smaller ramp, which is defined by the maximum allowed active edges, the network effects estimation system 216 can find the value of x, p₁, and p₂ that results in minimum variance keeping the maximum allowed edged fixed.

Referring back to FIG. 3, in some example embodiments, the estimation module 310 is configured to determine a plurality of different permutations of selection parameters for selecting treatment entities from an online network of entities. In some example embodiments, the selection parameters comprise a percentage of entities of an online network of entities to be selected for use as treatment entities (e.g., selection parameter x discussed), a probability by which a first entity in the online network of entities will have a common treatment type with a second entity that is connected by a first degree with the first entity (e.g., selection parameter p₁ discussed above), and a probability by which the first entity in the online network of entities will have a common treatment type with a third entity that is connected by a first degree with the second entity (e.g., selection parameter p₂ discussed above). In some example embodiments, the online network comprises a social network, such as the social networking system 210 of FIG. 2. However, other types of online networks are also within the scope of the present disclosure. In some example embodiments, the treatment comprises boosting display of online content of particular entities of the online network based on one or more criteria. Other types of treatments are also within the scope of the present disclosure.

In some example embodiments, the estimation module 310 is configured to, for each permutation of selection parameters in the plurality of permutations of selection parameters, calculate a corresponding variance in an effect value representing an effect of a treatment on the online network. In some example embodiments, the estimation module 310 is configured to calculate the corresponding variance in the effect value by calculating, for each one of a plurality of entities of the online network of entities, a corresponding effect value representing an effect of the treatment on the one of the plurality of entities based on an estimation model. The estimation model may comprise a linear model. However, other types of estimation models are also within the scope of the present disclosure. In some example embodiments, the calculating the corresponding effect values for the plurality of entities comprises performing a regression algorithm to generate the estimation model. However, other ways of generating the estimation model are also within the scope of the present disclosure. In some example embodiments, the estimation model is based on:
a) a number of first degree connection entities of the one of the plurality of entities that share a common treatment type from amongst a plurality of treatment types with the one of the plurality of entities (e.g., ηᵢ discussed above);
b) for each first degree connection entity of the one of the plurality of entities, a number of first degree connection entities of the first degree connection entity of the one of the plurality of entities that share a common treatment type from amongst a plurality of treatment types with the first degree connection entity of the one of the plurality of entities, the plurality of treatment types comprising a treated entity and a control entity (e.g., σⱼ discussed above); and
c) for each first degree connection entity of the one of the plurality of entities, a number of second degree connection entities of the one of the plurality of entities that are also a first degree connection entity of the first degree connection entity of the one of the plurality of entities (e.g., ξᵢⱼ discussed above).

In some example embodiments, the selection module 320 is configured to select one of the plurality of different permutations of selection parameters based on the corresponding variance of the one of the plurality of different permutations of selection parameters being lower than the corresponding variances of all of the other permutations of selection parameters in the plurality of different permutations of selection parameters. In this respect, the selection module 320 is minimizing the variance. In some example embodiments, the selection module 320 is configured to select a group of treatment entities from the online network of entities based on the selected one of the plurality of different permutations of selection parameters, such as described above with respect to FIG. 5.

In some example embodiments, the treatment module 330 is configured to apply the treatment to the group of treatment entities based on the selecting of the group of treatment entities. Here, the treatment module 330 may run the experiment, applying the treatment to the selected treatment entities, and not applying the treatment to selected control entities, and then measure the effect of the experiment, comparing the effect on the treatment entities to the effect on the control entities.

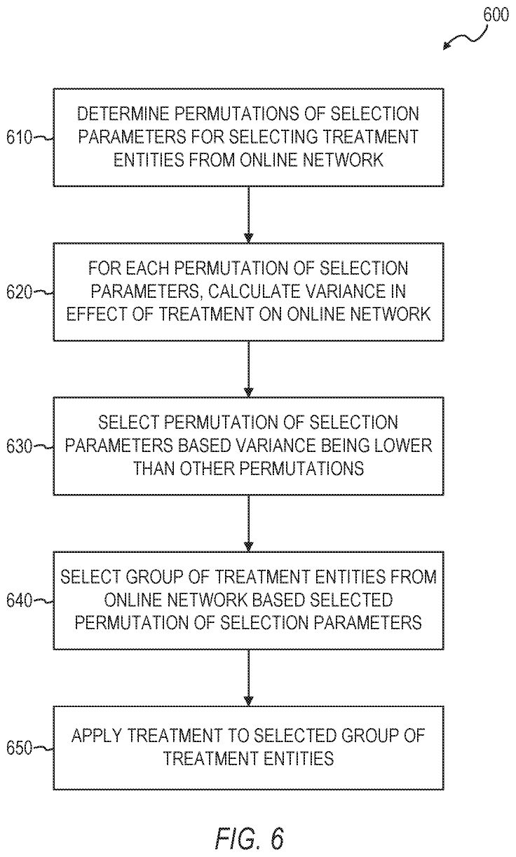

FIG. 6 is a flowchart illustrating a method of minimizing variance in the estimation of the effects of a treatment on an online network, in accordance with an example embodiment. The method 600 can be performed by processing logic that can comprise hardware (e.g., circuitry, dedicated logic, programmable logic, microcode, etc.), software (e.g., instructions run on a processing device), or a combination thereof. In one implementation, the method 600 is performed by the network effects estimation system 216 of FIG. 3, or any combination of one or more of its modules, as described above.

At operation 610, the network effects estimation system 216 determines a plurality of different permutations of selection parameters for selecting treatment entities from an online network of entities. In some example embodiments, the selection parameters comprise a percentage of entities of an online network of entities to be selected for use as treatment entities (e.g., selection parameter x discussed), a probability by which a first entity in the online network of entities will have a common treatment type with a second entity that is connected by a first degree with the first entity (e.g., selection parameter p₁ discussed above), and a probability by which the first entity in the online network of entities will have a common treatment type with a third entity that is connected by a first degree with the second entity (e.g., selection parameter p₂ discussed above). In some example embodiments, the online network comprises a social network, such as the social networking system 210 of FIG. 2. However, other types of online networks are also within the scope of the present disclosure. In some example embodiments, the treatment comprises boosting display of online content of particular entities of the online network based on one or more criteria. However, other types of treatments are also within the scope of the present disclosure.

At operation 620, the network effects estimation system 216, for each permutation of selection parameters in the plurality of permutations of selection parameters, calculates a corresponding variance in an effect value representing an effect of a treatment on the online network. In some example embodiments, the estimation module 310 is configured to calculate the corresponding variance in the effect value by calculating, for each one of a plurality of entities of the online network of entities, a corresponding effect value representing an effect of the treatment on the one of the plurality of entities based on an estimation model. The estimation model may comprise a linear model. However, other types of estimation models are also within the scope of the present disclosure. In some example embodiments, the calculating the corresponding effect values for the plurality of entities comprises performing a regression algorithm to generate the estimation model. However, other ways of generating the estimation model are also within the scope of the present disclosure. In some example embodiments, the estimation model is based on:
a) a number of first degree connection entities of the one of the plurality of entities that share a common treatment type from amongst a plurality of treatment types with the one of the plurality of entities (e.g., ηᵢ discussed above);
b) for each first degree connection entity of the one of the plurality of entities, a number of first degree connection entities of the first degree connection entity of the one of the plurality of entities that share a common treatment type from amongst a plurality of treatment types with the first degree connection entity of the one of the plurality of entities, the plurality of treatment types comprising a treated entity and a control entity (e.g., σⱼ discussed above); and
c) for each first degree connection entity of the one of the plurality of entities, a number of second degree connection entities of the one of the plurality of entities that are also a first degree connection entity of the first degree connection entity of the one of the plurality of entities (e.g., ξᵢⱼ discussed above).

At operation 630, the network effects estimation system 216 selects one of the plurality of different permutations of selection parameters based on the corresponding variance of the one of the plurality of different permutations of selection parameters being lower than the corresponding variances of all of the other permutations of selection parameters in the plurality of different permutations of selection parameters.

At operation 640, the network effects estimation system 216 selects a group of treatment entities from the online network of entities based on the selected one of the plurality of different permutations of selection parameters, such as discussed above with respect to FIG. 5.

At operation 650, the network effects estimation system 216 applies the treatment to the group of treatment entities based on the selecting of the group of treatment entities. Here, the network effects estimation system 216 may run the experiment, applying the treatment to the selected treatment entities, and not applying the treatment to selected control entities, and then measure the effect of the experiment, comparing the effect on the treatment entities to the effect on the control entities.

It is contemplated that any of the other features described within the present disclosure can be incorporated into the method 600.

### Example Mobile Device

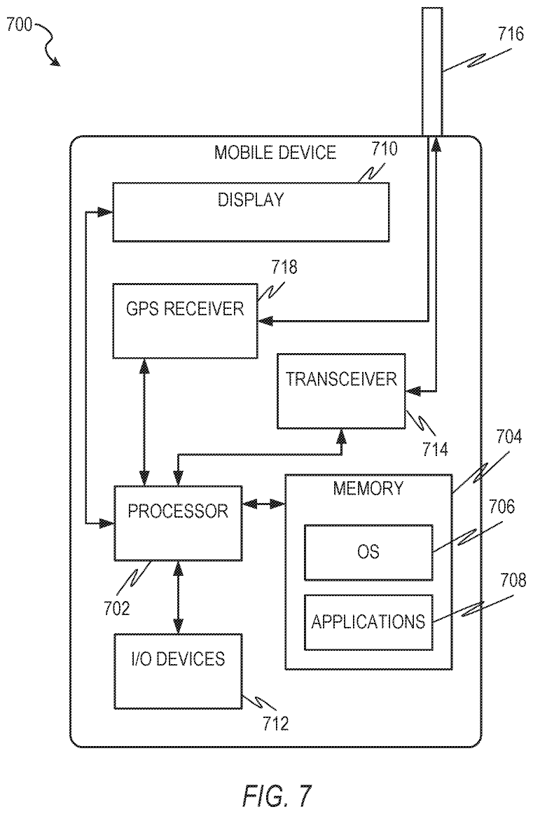

FIG. 7 is a block diagram illustrating a mobile device 700, according to an example embodiment. The mobile device 700 can include a processor 702. The processor 702 can be any of a variety of different types of commercially available processors suitable for mobile devices 700 (for example, an XScale architecture microprocessor, a Microprocessor without Interlocked Pipeline Stages (MIPS) architecture processor, or another type of processor). A memory 704, such as a random access memory (RAM), a Flash memory, or other type of memory, is typically accessible to the processor 702. The memory 704 can be adapted to store an operating system (OS) 706, as well as application programs 708, such as a mobile location-enabled application that can provide location-based services (LBSs) to a user. The processor 702 can be coupled, either directly or via appropriate intermediary hardware, to a display 710 and to one or more input/output (I/O) devices 712, such as a keypad, a touch panel sensor, a microphone, and the like. Similarly, in some embodiments, the processor 702 can be coupled to a transceiver 714 that interfaces with an antenna 716. The transceiver 714 can be configured to both transmit and receive cellular network signals, wireless data signals, or other types of signals via the antenna 716, depending on the nature of the mobile device 700. Further, in some configurations, a GPS receiver 718 can also make use of the antenna 716 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

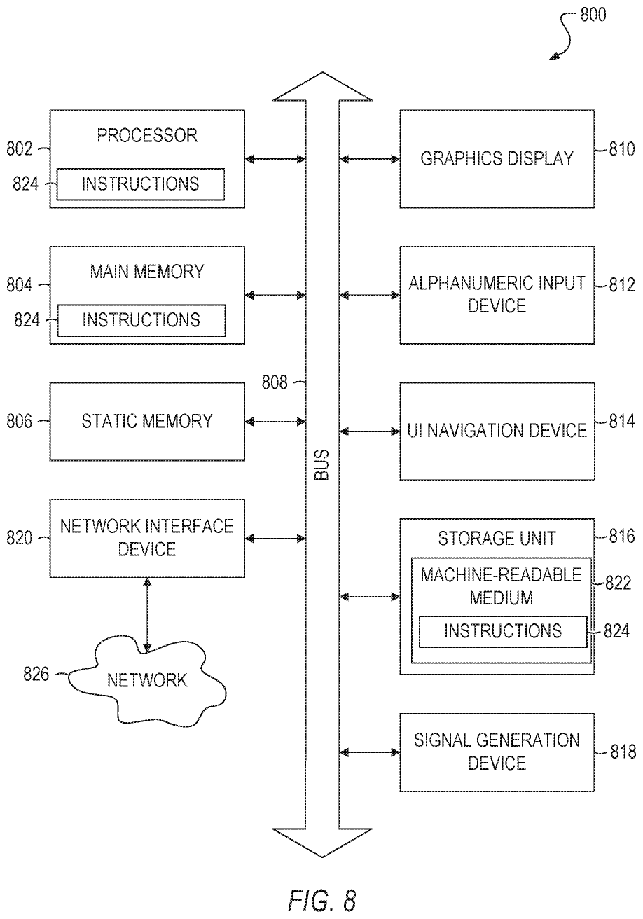

FIG. 8 is a block diagram of an example computer system 800 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a graphics display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation device 814 (e.g., a mouse), a storage unit 816, a signal generation device 818 (e.g., a speaker) and a network interface device 820.

### Machine-Readable Medium

The storage unit 816 includes a machine-readable medium 822 on which is stored one or more sets of instructions and data structures (e.g., software) 824 embodying or utilized by any one or more of the methodologies or functions described herein. The instructions 824 may also reside, completely or at least partially, within the main memory 804 and/or within the processor 802 during execution thereof by the computer system 800, the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions (e.g., instructions 824) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
determining, by a computer system having a memory and at least one hardware processor, a plurality of different permutations of selection parameters for selecting treatment entities from an online network of entities, the selection parameters comprising a percentage of entities of an online network of entities to be selected for use as treatment entities, a probability by which a first entity in the online network of entities will have a common treatment type with a second entity that is connected by a first degree with the first entity, and a probability by which the first entity in the online network of entities will have a common treatment type with a third entity that is connected by a first degree with the second entity;
for each permutation of selection parameters in the plurality of permutations of selection parameters, calculating, by the computer system, a corresponding variance in an effect value representing an effect of a treatment on the online network;
selecting, by the computer system, one of the plurality of different permutations of selection parameters based on the corresponding variance of the one of the plurality of different permutations of selection parameters being lower than the corresponding variances of all of the other permutations of selection parameters in the plurality of different permutations of selection parameters;
selecting, by the computer system, a group of treatment entities from the online network of entities based on the selected one of the plurality of different permutations of selection parameters; and
applying, by the computer system, the treatment to the group of treatment entities based on the selecting of the group of treatment entities.

2. The computer-implemented method of claim 1, wherein the calculating the corresponding variance in the effect value comprises, calculating, for each one of a plurality of entities of the online network of entities, a corresponding effect value representing an effect of the treatment on the one of the plurality of entities based on an estimation model, the estimation model being based on:
a number of first degree connection entities of the one of the plurality of entities that share a common treatment type from amongst a plurality of treatment types with the one of the plurality of entities;
for each first degree connection entity of the one of the plurality of entities, a number of first degree connection entities of the first degree connection entity of the one of the plurality of entities that share a common treatment type from amongst a plurality of treatment types with the first degree connection entity of the one of the plurality of entities, the plurality of treatment types comprising a treated entity and a control entity; and
for each first degree connection entity of the one of the plurality of entities, a number of second degree connection entities of the one of the plurality of entities that are also a first degree connection entity of the first degree connection entity of the one of the plurality of entities.

3. The computer-implemented method of claim 2, wherein the estimation model is based on a proportion of the number of first degree connection entities of the one of the plurality of entities that share a common treatment type from amongst the plurality of treatment types with the one of the plurality of entities to a total number of all first degree connection entities of the one of the plurality of connection entities.

4. The computer-implemented method of claim 2, wherein the calculating the corresponding effect values for the plurality of entities comprises performing a regression algorithm to generate the estimation model.

5. The computer-implemented method of claim 2, wherein the estimation model comprises a linear model.

6. The computer-implemented method of claim 1, wherein the online network comprises a social network.

7. The computer-implemented method of claim 1, wherein the treatment comprises boosting display of online content of particular entities of the online network based on one or more criteria.

8. A system comprising:
at least one hardware processor; and
a non-transitory machine-readable medium embodying a set of instructions that, when executed by the at least one hardware processor, cause the at least one processor to perform operations, the operations comprising:
determining a plurality of different permutations of selection parameters for selecting treatment entities from an online network of entities, the selection parameters comprising a percentage of entities of an online network of entities to be selected for use as treatment entities, a probability by which a first entity in the online network of entities will have a common treatment type with a second entity that is connected by a first degree with the first entity, and a probability by which the first entity in the online network of entities will have a common treatment type with a third entity that is connected by a first degree with the second entity;
for each permutation of selection parameters in the plurality of permutations of selection parameters, calculating a corresponding variance in an effect value representing an effect of a treatment on the online network;
selecting one of the plurality of different permutations of selection parameters based on the corresponding variance of the one of the plurality of different permutations of selection parameters being lower than the corresponding variances of all of the other permutations of selection parameters in the plurality of different permutations of selection parameters;
selecting a group of treatment entities from the online network of entities based on the selected one of the plurality of different permutations of selection parameters; and
applying the treatment to the group of treatment entities based on the selecting of the group of treatment entities.

9. The system of claim 8, wherein the calculating the corresponding variance in the effect value comprises, calculating, for each one of a plurality of entities of the online network of entities, a corresponding effect value representing an effect of the treatment on the one of the plurality of entities based on an estimation model, the estimation model being based on:
a number of first degree connection entities of the one of the plurality of entities that share a common treatment type from amongst a plurality of treatment types with the one of the plurality of entities;
for each first degree connection entity of the one of the plurality of entities, a number of first degree connection entities of the first degree connection entity of the one of the plurality of entities that share a common treatment type from amongst a plurality of treatment types with the first degree connection entity of the one of the plurality of entities, the plurality of treatment types comprising a treated entity and a control entity; and
for each first degree connection entity of the one of the plurality of entities, a number of second degree connection entities of the one of the plurality of entities that are also a first degree connection entity of the first degree connection entity of the one of the plurality of entities.

10. The system of claim 9, wherein the estimation model is based on a proportion of the number of first degree connection entities of the one of the plurality of entities that share a common treatment type from amongst the plurality of treatment types with the one of the plurality of entities to a total number of all first degree connection entities of the one of the plurality of connection entities.

11. The system of claim 9, wherein the calculating the corresponding effect values for the plurality of entities comprises performing a regression algorithm to generate the estimation model.

12. The system of claim 9, wherein the estimation model comprises a linear model.

13. The system of claim 8, wherein the online network comprises a social network.

14. The system of claim 8, wherein the treatment comprises boosting display of online content of particular entities of the online network based on one or more criteria.

15. A non-transitory machine-readable medium embodying a set of instructions that, when executed by at least one hardware processor, cause the processor to perform operations, the operations comprising:
determining a plurality of different permutations of selection parameters for selecting treatment entities from an online network of entities, the selection parameters comprising a percentage of entities of an online network of entities to be selected for use as treatment entities, a probability by which a first entity in the online network of entities will have a common treatment type with a second entity that is connected by a first degree with the first entity, and a probability by which the first entity in the online network of entities will have a common treatment type with a third entity that is connected by a first degree with the second entity;
for each permutation of selection parameters in the plurality of permutations of selection parameters, calculating a corresponding variance in an effect value representing an effect of a treatment on the online network;
selecting one of the plurality of different permutations of selection parameters based on the corresponding variance of the one of the plurality of different permutations of selection parameters being lower than the corresponding variances of all of the other permutations of selection parameters in the plurality of different permutations of selection parameters;
selecting a group of treatment entities from the online network of entities based on the selected one of the plurality of different permutations of selection parameters; and
applying the treatment to the group of treatment entities based on the selecting of the group of treatment entities.

16. The non-transitory machine-readable medium of claim 15, wherein the calculating the corresponding variance in the effect value comprises, calculating, for each one of a plurality of entities of the online network of entities, a corresponding effect value representing an effect of the treatment on the one of the plurality of entities based on an estimation model, the estimation model being based on:
a number of first degree connection entities of the one of the plurality of entities that share a common treatment type from amongst a plurality of treatment types with the one of the plurality of entities;
for each first degree connection entity of the one of the plurality of entities, a number of first degree connection entities of the first degree connection entity of the one of the plurality of entities that share a common treatment type from amongst a plurality of treatment types with the first degree connection entity of the one of the plurality of entities, the plurality of treatment types comprising a treated entity and a control entity; and
for each first degree connection entity of the one of the plurality of entities, a number of second degree connection entities of the one of the plurality of entities that are also a first degree connection entity of the first degree connection entity of the one of the plurality of entities.

17. The non-transitory machine-readable medium of claim 16, wherein the estimation model is based on a proportion of the number of first degree connection entities of the one of the plurality of entities that share a common treatment type from amongst the plurality of treatment types with the one of the plurality of entities to a total number of all first degree connection entities of the one of the plurality of connection entities.

18. The non-transitory machine-readable medium of claim 16, wherein the calculating the corresponding effect values for the plurality of entities comprises performing a regression algorithm to generate the estimation model.

19. The non-transitory machine-readable medium of claim 15, wherein the online network comprises a social network.

20. The non-transitory machine-readable medium of claim 15, wherein the treatment comprises boosting display of online content of particular entities of the online network based on one or more criteria.
